(19) United States
(12) Patent Application Publication
(10) Pub. No.: US 2026/0238898 A1
(43) Pub. Date: Aug. 13, 2026

(54) IMAGE SENSOR, ARRANGEMENT STRUCTURE, AND CONTROL METHOD

(71) Applicant: SMARTSENS TECHNOLOGY(HK) CO., LIMITED, HK (CN)

(72) Inventors: Shengxin ZHANG, Shanghai (CN); Wanqing WANG, Shanghai (CN)

(73) Assignee: SMARTSENS TECHNOLOGY(HK) CO., LIMITED, HK (CN)

(21) Appl. No.: 19/344,431

(22) Filed: Sep. 29, 2025

(30) Foreign Application Priority Data
Feb. 8, 2025 (CN) 2025101409998
Feb. 8, 2025 (CN) 2025202017759

(51) Int. Cl. H04N 25/77; H04N 25/78

(52) U.S. Cl. CPC H04N 25/77; H04N 25/78

(57) ABSTRACT

An image sensor, an arrangement structure and a control method are provided. The image sensor comprises pixel units arranged in an array. Each pixel unit comprises a conversion output module, a first-mode operation module, and a second-mode operation module. The conversion output module outputs a first set of signals comprising a first reset signal and a pixel signal, and outputs a second set of signals comprising a second reset signal and an overflow signal. The first-mode operation module is connected to the conversion output module. In a first mode, the first-mode operation module stores and reads out at least one of the first set of signals and the second set of signals. The second-mode operation module is connected to the conversion output module. In a second mode, the second-mode operation module reads out at least one of the first set of signals and the second set of signals.

### FIELD OF THE INVENTION

The present disclosure relates to the technical field of image sensors, and in particular relates to an image sensor, an arrangement structure and a control method.

### BACKGROUND OF THE INVENTION

As image sensor technology continues to advance, the integrated use of multiple sensor types is becoming increasingly prevalent. For example, in certain operating scenarios, a rolling-shutter image sensor may be required to achieve superior image quality. In contrast, under different conditions, a global-shutter sensor is often preferred due to its faster readout speed. Consequently, it is common for multiple device terminals to work in coordination, typically by switching between them based on the specific operating requirements. However, this frequent switching between device terminals introduces complexity and inefficiency, making it a significant technical challenge for professionals in the field.

It should be noted that the above introduction to the technical background is only for the convenience of a clear and complete description of the technical solution of the present disclosure. It is intended to facilitate understanding among those skilled in the field and should not be construed as an indication that the disclosed technical solutions are already well known in the industry simply because they appear in the background section of the present disclosure.

### SUMMARY OF THE INVENTION

The present disclosure provides an image sensor, an arrangement structure and a control method, which address the issue in existing technologies that require switching between multiple device terminals under varying operating conditions to achieve fusion of different image sensors.

The image sensor of the present disclosure comprises pixel units arranged in an array. Each of the pixel units comprises a conversion output module, a first-mode operation module, and a second-mode operation module.

The conversion output module is configured to output a first set of signals comprising a first reset signal and a pixel signal, and output a second set of signals comprising a second reset signal and an overflow signal.

The first-mode operation module is connected to the conversion output module. In a first mode, the first-mode operation module is configured to store and read out at least one of the first set of signals and the second set of signals.

The second-mode operation module is connected to the conversion output module. In a second mode, the second-mode operation module is configured to read out at least one of the first set of signals and the second set of signals.

Regarding the arrangement structure for the image sensor of the present disclosure, the conversion output module comprises a photoreceptor portion, an overflow portion, a first reset portion and an output portion. The overflow portion and the first reset portion are disposed close to a first side of the photoreceptor portion, and the output portion is disposed close to a second side of the photoreceptor portion. The overflow portion and the first reset portion are arranged in a staggered manner.

The first-mode operation module comprises a first storage readout portion disposed close to the second side of the photoreceptor portion.

The second-mode operation module is disposed close to the second side of the photoreceptor portion.

The method for controlling the image sensor of the present disclosure comprises: in the first mode, storing and reading out, based on the conversion output module and the first-mode operation module, at least one of the first set of signals and the second set of signals; and in the second mode, reading out, based on the conversion output module and the second-mode operation module, at least one of the first set of signals and the second set of signals.

As described above, the image sensor, the arrangement structure, and the control method of the present disclosure enable switching between the first mode and the second mode within a single image sensor through the design of the conversion output module, the first-mode operation module, and the second-mode operation module, thereby eliminating the need to switch between different image sensors to achieve mode transition.

### BRIEF DESCRIPTION OF DRAWINGS

FIG. 1 shows a schematic structural diagram of a pixel unit according to an embodiment of the present disclosure.

FIG. 2 shows a schematic structural diagram of the pixel unit shown in FIG. 1, in which the pixel unit is adjusted such that an overflow portion of the pixel unit shares a first storage capacitor with a first storage readout portion.

FIG. 3 shows a schematic structural diagram of the pixel unit shown in FIG. 1, in which the pixel unit is adjusted such that the overflow portion of the pixel unit shares a second storage capacitor with the first storage readout portion.

FIG. 4 shows a schematic structural diagram of a pixel unit according to another embodiment of the present disclosure.

FIG. 5 shows a schematic structural diagram of the pixel unit shown in FIG. 4, in which the pixel unit is adjusted such that a first storage readout portion shares a second source-following transistor and a first row selection transistor with a second storage readout portion.

FIG. 6 shows another schematic structural diagram of the pixel unit shown in FIG. 4, in which the pixel unit is adjusted such that the first storage readout portion shares the second source-following transistor and the first row selection transistor with the second storage readout portion.

FIG. 7 shows a schematic structural diagram of the pixel unit shown in FIG. 6, in which the pixel unit is adjusted such that an overflow portion of the pixel unit shares a second storage capacitor with the first storage readout portion.

FIG. 8 shows a schematic structural diagram of the pixel unit shown in FIG. 6, in which the pixel unit is adjusted such that the overflow portion of the pixel unit shares a fourth storage capacitor with the second storage readout portion.

FIG. 9 shows a schematic diagram of an arrangement structure of an image sensor according to an embodiment of the present disclosure.

FIG. 10 is a schematic diagram showing a first arrangement of multiple capacitors according to an embodiment of the present disclosure.

FIG. 11 is a schematic diagram showing a second arrangement of multiple capacitors according to an embodiment of the present disclosure.

FIG. 12 is a schematic diagram showing a third arrangement of multiple capacitors according to an embodiment of the present disclosure.

FIG. 13 is a schematic diagram showing a fourth arrangement of multiple capacitors according to an embodiment of the present disclosure.

FIG. 14 is a schematic diagram showing a fifth arrangement of multiple capacitors according to an embodiment of the present disclosure.

### REFERENCE NUMERALS

100 Pixel unit
110 Conversion output module
111 Photoreceptor portion
112 Overflow portion
113 First reset portion
114 Output portion
115 Second reset portion
116 Gain portion
120 First-mode operation module
121 First storage readout portion
122 Second storage readout portion
130 Second-mode operation module

### DETAILED DESCRIPTION OF THE INVENTION

The embodiments of the present disclosure will be described below. Those skilled can easily understand disclosure advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

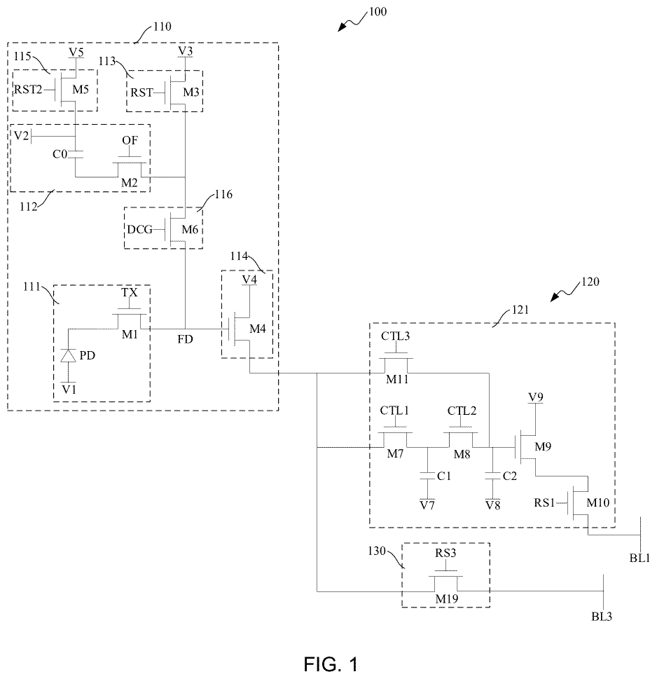

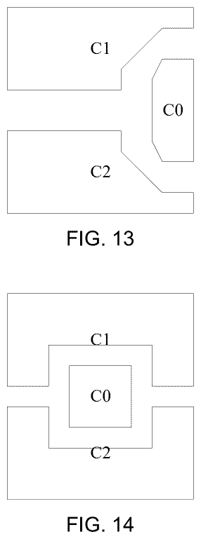

Refer to FIGS. 1 to 14. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components'layout may also be more complicated.

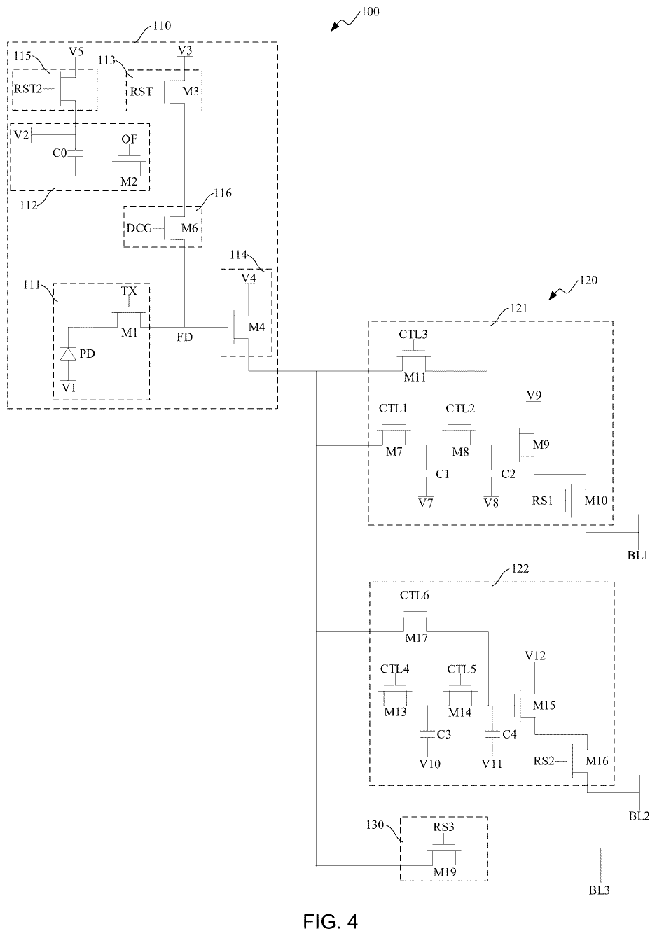

As shown in FIGS. 1 and 4, the present disclosure provides an image sensor. The image sensor comprises pixel units 100 arranged in an array. Each of the pixel units 100 comprises a conversion output module 110, a first-mode operation module 120, and a second-mode operation module 130.

The conversion output module 110 is configured to output a first set of signals comprising a first reset signal and a pixel signal, and output a second set of signals comprising a second reset signal and an overflow signal. As an example, the conversion output module 110 comprises a photoreceptor portion 111, an overflow portion 112, a first reset portion 113, and an output portion 114. Further, the conversion output module 110 comprises at least one of a second reset portion 115 and a gain portion 116.

The photoreceptor portion 111 is coupled to a floating diffusion (FD) node. The photoreceptor portion 111 is configured to perform accumulation of photogenerated electrons based on photoelectric effect, and transfer the photogenerated electrons at least to the FD node, to read out the pixel signal. As an example, the photoreceptor portion 111 comprises a transmission transistor M1 and a photoreceptor element PD. A control end of the transmission transistor M1 receives a transmission control signal TX, a first end of the transmission transistor M1 is coupled to the FD node, and a second end of the transmission transistor M1 is coupled to a first potential (e.g., a ground potential or a negative potential) V1 through the photoreceptor element. It should be noted that in some implementations, the transmission transistor M1 and the photoreceptor element PD are configured in a one-to-one correspondence within the photoreceptor portion 111. The quantity of each of the transmission transistor M1 and the photoreceptor element PD may be one or more.

The overflow portion 112 is coupled to the FD node or the photoreceptor portion 111. The overflow portion 112 is configured to store a part of the photogenerated electrons overflowing from the FD node or the photoreceptor portion 111, to read out the overflow signal. It should be noted that if the charge quantity of the photogenerated electrons does not exceed the storage capacity of the FD node or the photoreceptor portion 111, no photogenerated electrons will overflow from the FD node or the photoreceptor portion 111, which is equivalent to the absence of an overflow signal. As an example, the overflow portion 112 comprises an overflow transistor M2 and an overflow capacitor C0. A control end of the overflow transistor M2 receives an overflow control signal OF, a first end of the overflow transistor M2 is coupled to the FD node or the photoreceptor portion 111, and a second end of the overflow transistor M2 is coupled to a second potential (e.g., a ground potential) V2 through the overflow capacitor C0. In practice, the overflow capacitor C0 is realized using a Metal-Insulator-Metal (MIM) capacitor. As shown in FIGS. 1 to 4, the overflow portion 112 is coupled to the FD node.

The first reset portion 113 is coupled to the FD node. The first reset portion 113 is configured to reset at least the FD node, to read out a corresponding one of the first reset signal and the second reset signal. The first reset portion 113 is also configured to reset the photoreceptor portion 111 and the overflow portion 112. As an example, the first reset portion 113 comprises a first reset transistor M3. A control end of the first reset transistor M3 receives a first reset control signal RST1, a first end of the first reset transistor M3 is coupled to a third potential (e.g., a power supply potential) V3, and a second end of the first reset transistor M3 is coupled to the FD node.

The output portion 114 is coupled to the FD node and configured to amplify a corresponding one of the first set of signals and the second set of signals, such as amplifying and outputting the first reset signal and the pixel signal, and/or amplifying and outputting the second reset signal and the overflow signal. As an example, the output portion 114 comprises a first source-following transistor M4. A control end of the first source-following transistor M4 is coupled to the FD node, a first end of the first source-following transistor M4 is coupled to a fourth potential (e.g., a power supply potential or a variable potential) V4, and a second end of the first source-following transistor M4 serves as an output of the conversion output module 110.

The conversion output module 110 further comprises the second reset portion 115, and the second reset portion 115 is coupled to the overflow portion 112 to reset at least the overflow portion 112. As an example, the second reset portion 115 may perform a fast reset of the overflow portion 112 in cooperation with the first reset portion 113. As an example, the second reset portion 115 comprises a second reset transistor M5. A control end of the second reset transistor M5 receives a second reset control signal RST2, a first end of the second reset transistor M5 is coupled to a fifth potential V5, and a second end of the second reset transistor M5 is coupled to the overflow portion 112. As an example, the second end of the second reset transistor M5 is coupled to a plate of the overflow capacitor C0 away from the overflow transistor M2. The fifth potential V5 and the third potential V3 are set to the same potential, such as a power supply potential, to facilitate a fast reset of the overflow capacitor C0. Further, the first end of the second reset transistor M5 and the first end of the first reset transistor M3 are connected to a common power supply voltage transmission line, thereby enabling fast reset based on the second reset portion 115 and the first reset portion 113.

The conversion output module 110 further comprises the gain portion 116, and the gain portion 116 is coupled to the FD node, for switching between conversion gains. The conversion gains comprise a first conversion gain and a second conversion gain. As an example, the gain portion 116 comprises a gain transistor M6. The gain transistor M6 is coupled between the first reset portion 113 and the FD node. A control end of the gain transistor M6 receives a gain control signal DCG. A first end of the gain transistor M6 is coupled to the first reset portion 113 (e.g., to the second end of the first reset transistor M3 within the first reset portion 113), while a second end of the gain transistor M6 is coupled to the FD node. In this configuration, the first end of the overflow transistor M2 in the overflow portion 112 is no longer directly coupled to the FD node, but is instead directly coupled to the first end of the gain transistor M6. As another example, the gain transistor M6 may also be directly coupled to the FD node. The control end of the gain transistor M6 receives the gain control signal DCG, the first end of the gain transistor M6 is coupled to the FD node, and the second end of the gain transistor M6 is coupled to a sixth potential, at which time, the first reset portion 113 may also be coupled directly to the FD node.

The first-mode operation module 120 is connected to the conversion output module 110. In a first mode, the first-mode operation module 120 is configured to store and read out at least one of the first set of signals and the second set of signals. As an example, the first-mode operation module 120 comprises a first storage readout portion 121, as shown in FIG. 1. As another example, the first-mode operation module 120 further comprises a second storage readout portion 122, as shown in FIG. 4. In practice, when the conversion output module 110 does not comprise the gain portion 116, the first-mode operation module 120 comprises only the first storage readout portion 121 (i.e., the first-mode operation module 120 does not comprise the second storage readout portion 122); when the conversion output module 110 comprises the gain portion 116, the first-mode operation module 120 may comprise either the first storage readout portion 121 alone, or both the first storage readout portion 121 and the second storage readout portion 122.

The first storage readout portion 121 is coupled to the output of the conversion output module 110. When the conversion output module 110 does not comprise the gain portion 116, at least the first reset signal and the pixel signal are respectively stored and read out; when the conversion output module 110 comprises the gain portion 116, at least the first reset signal and the pixel signal corresponding to the gain portion 116 under any of the conversion gains are respectively stored and read out. As shown in FIG. 1, the first storage readout portion 121 comprises a first storage transistor M7, a second storage transistor M8, a first storage capacitor C1, a second storage capacitor C2, a second source-following transistor M9, and a first row selection transistor M10. The first storage readout portion 121 may further comprise a third storage transistor M11.

A control end of the first storage transistor M7 receives a first storage control signal CTL1, a first end of the first storage transistor M7 is coupled to the output of the conversion output module 110 (e.g., to the second end of the first source-following transistor M4 in the output portion 114), and a second end of the first storage transistor M7 is coupled to a seventh potential (e.g., a ground potential) V7 through the first storage capacitor C1 and is further coupled to a first end of the second storage transistor M8. A control end of the second storage transistor M8 receives a second storage control signal CTL2, and a second end of the second storage transistor M8 is coupled to an eighth potential V8 through the second storage capacitor C2 and is further coupled to a control end of the second source-following transistor M9. A first end of the second source-following transistor M9 is coupled to a ninth potential (e.g., a power supply potential or a variable potential) V9, and a second end of the second source-following transistor M9 is coupled to a first end of the first row selection transistor M10. A control end of the first row selection transistor M10 receives a first row selection control signal RS1, and a second end of the first row selection transistor M10 is coupled to a first column line BL1. In the above configuration, the first reset signal and the pixel signal are respectively stored by controlling the first storage transistor M7 and the second storage transistor M8, specifically, the first reset signal is first stored in the second storage capacitor C2 by turning on both the first storage transistor M7 and the second storage transistor M8, subsequently the pixel signal is stored in the first storage capacitor C1 by turning on the first storage transistor M7 and turning off the second storage transistor M8. The first reset signal and the pixel signal are respectively read out by controlling the first row selection transistor M10 and the second storage transistor M8, specifically, the first reset signal stored in the second storage capacitor C2 is first read out by turning on the first row selection transistor M10, subsequently the pixel signal stored in the first storage capacitor C1 is read out by turning on the second storage transistor M8. It should be noted that the above description of storage and readout provides a generalized explanation of storing and reading the first reset signal and the pixel signal, to facilitate understanding of signal acquisition and the derivation of a differential value based on the acquired signals for implementing correlation double sampling. In practice, those skilled in the art will appreciate that the first reset signal is also stored in the first storage capacitor C1 during the storage process. Upon readout, the difference between the first reset signal and the corresponding pixel signal can be obtained, thereby enabling correlation double sampling.

The first storage readout portion 121 further comprises the third storage transistor M11. A control end of the third storage transistor M11 receives a third storage control signal CTL3, a first end of the third storage transistor M11 is coupled to the first end of the first storage transistor M7, and a second end of the third storage transistor M11 is coupled to the second end of the second storage transistor M8. By incorporating the third storage transistor M11, the first reset signal can be stored in the second storage capacitor C2 by directly turning on the third storage transistor M11. In this configuration, the first reset signal bypasses the first storage capacitor C1, thereby avoiding any influence on the first storage capacitor C1, at which time, the first storage transistor M7 and the second storage transistor M8 remain in an off state.

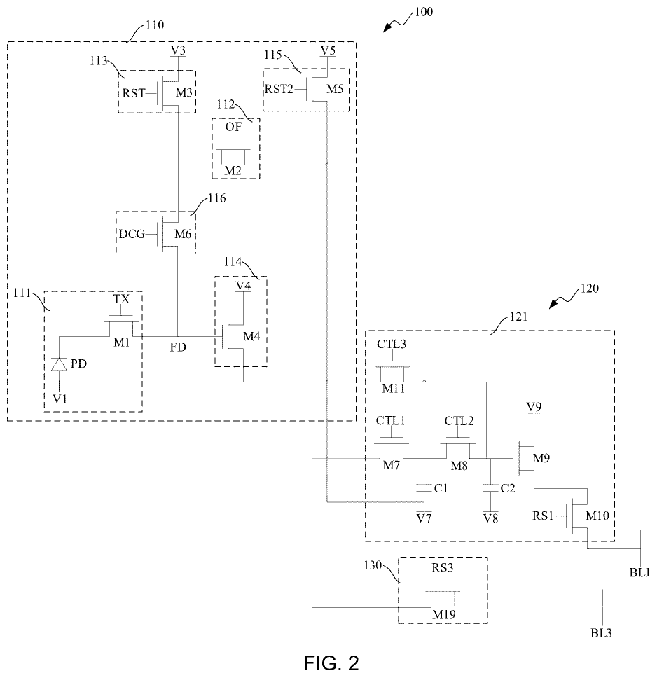

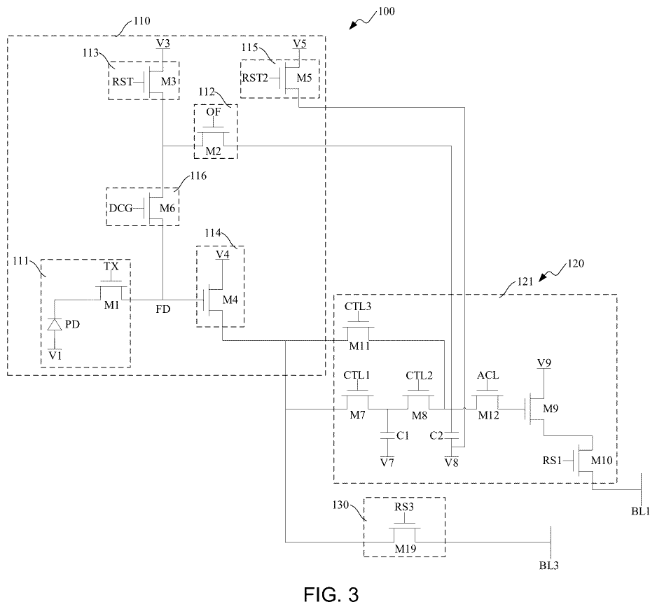

In practice, the first storage capacitor C1 and the second storage capacitor C2 are realized using MIM capacitors. The capacitance of the first storage capacitor C1 and the capacitance of the second storage capacitor C2 are typically designed to be relatively large to suppress noise in global shutter (GS) mode. In one implementation, the capacitance of the first storage capacitor C1 and the capacitance of the second storage capacitor C2 are greater than the capacitance of the overflow capacitor C0. In one implementation, the capacitance of the first storage capacitor C1 and the capacitance of the second storage capacitor C2 are designed to be equal. In one implementation, for the consideration of reducing the circuit area, the overflow portion 112 can be designed to share the first storage capacitor C1 with the first storage readout portion 121, at which time the overflow portion 112 no longer comprises the overflow capacitor C0, and the second end of the overflow transistor M2 is no longer coupled to the second potential V2 through the overflow capacitor C0, but is instead coupled to the seventh potential V7 through the first storage capacitor C1, as shown in FIG. 2. It is also possible to design the overflow portion 112 to share the second storage capacitor C2 with the first storage readout portion 121, at which time the overflow portion 112 no longer comprises the overflow capacitor C0, and the second end of the overflow transistor M2 is no longer coupled to the second potential V2 through the overflow capacitor C0, but is instead coupled to the eighth potential V8 through the second storage capacitor C2, as shown in FIG. 3. In a further design, the first storage readout portion 121 also comprises an auxiliary control transistor M12. The auxiliary control transistor M12 is coupled between the multiplexed second storage capacitor C2 and the corresponding second source-following transistor M9. A control end of the auxiliary control transistor M12 receives an auxiliary control signal ACL, a first end of the auxiliary control transistor M12 is coupled to a plate of the second storage capacitor C2 away from the eighth potential V8, and a second end of the auxiliary control transistor M12 is coupled to the control end of the second source-following transistor M9.

For the above two alternative schemes, when the conversion output module 110 comprises the second reset portion 115, the coupling of the second reset portion 115 can be adjusted as follows: in the scheme where the first storage capacitor C1 is shared by the second reset portion 115 and the first storage readout portion 121, the second end of the second reset transistor M5 in the second reset portion 115 is no longer coupled to the plate of the overflow capacitor C0 away from the overflow transistor M2 (i.e., to the plate of the overflow capacitor C0 close to the second potential V2), but is instead coupled to a plate of the first storage capacitor C1 close to the seventh potential V7, to facilitate a fast reset of the first storage capacitor C1 by cooperating with the first reset portion 113, as shown in FIG. 2; in the scheme where the second storage capacitor C2 is shared by the second reset portion 115 and the first storage readout portion 121, the second end of the second reset transistor M5 in the second reset portion 115 is no longer coupled to the plate of the overflow capacitor C0 close to the second potential V2, but is instead coupled to a plate of the second storage capacitor C2 close to the eighth potential V8, to facilitate a fast reset of the second storage capacitor C2 by cooperating with the first reset portion 113, as shown in FIG. 3.

When the first-mode operation module 120 comprises the second storage readout portion 122 (i.e., when the first-mode operation module 120 comprises both the first storage readout portion 121 and the second storage readout portion 122), the first storage readout portion 121 is configured to store and read out the first reset signal and the pixel signal corresponding to the gain portion 116 under the first conversion gain, and the second storage readout portion 122 is configured to store and read out the first reset signal and the pixel signal corresponding to the gain portion 116 under the second conversion gain. As shown in FIG. 4, the second storage readout portion 122 comprises a fourth storage transistor M13, a fifth storage transistor M14, a third storage capacitor C3, a fourth storage capacitor C4, a third source-following transistor M15, and a second row selection transistor M16. The second storage readout portion 122 may further comprise a sixth storage transistor M17.

A control end of the fourth storage transistor M13 receives a fourth storage control signal CTL4, a first end of the fourth storage transistor M13 is coupled to the output of the conversion output module 110 (e.g., to the second end of the first source-following transistor M4 in the output portion 114), and a second end of the fourth storage transistor M13 is coupled to a tenth potential (e.g., a ground potential) V10 through the third storage capacitor C3, and is further coupled to a first end of the fifth storage transistor M14. A control end of the fifth storage transistor M14 receives a fifth storage control signal CTL5, and a second end of the fifth storage transistor M14 is coupled to an eleventh potential (e.g., a ground potential) V11 through the fourth storage capacitor C4, and is further coupled to a control end of the third source-following transistor M15. A first end of the third source-following transistor M15 is coupled to a twelfth potential (e.g., a power supply potential or a variable potential) V12, and a second end of the third source-following transistor M15 is coupled to a first end of the second row selection transistor M16. A control end of the second row selection transistor M16 receives a second row selection control signal RS2, and a second end of the second row selection transistor M16 is coupled to a second column line BL2. It should be noted that the operations of storing and reading out, by the second storage readout portion 122, the first reset signal and the pixel signal corresponding to the gain portion 116 under the second conversion gain are the same as those performed by the first storage readout portion 121, as an example.

When the second storage readout portion 122 further comprises the sixth storage transistor M17, a control end of the sixth storage transistor M17 receives a sixth storage control signal CTL6, a first end of the sixth storage transistor M17 is coupled to the first end of the fourth storage transistor M13, and a second end of the sixth storage transistor M17 is coupled to the second end of the fifth storage transistor M14. By introducing the sixth storage transistor M17, the first reset signal under the second conversion gain can be stored in the fourth storage capacitor C4 by directly turning on the sixth storage transistor M17. In this configuration, the first reset signal under the second conversion gain bypasses the third storage capacitor C3, thereby avoiding any influence on the third storage capacitor C3, at which time, the fourth storage transistor M13 and the fifth storage transistor M14 remain in an off state.

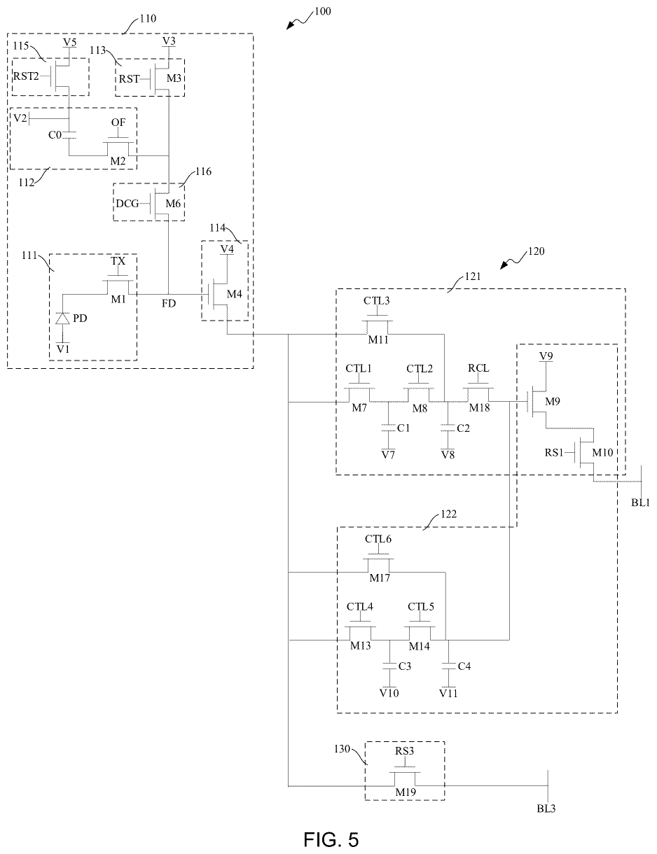

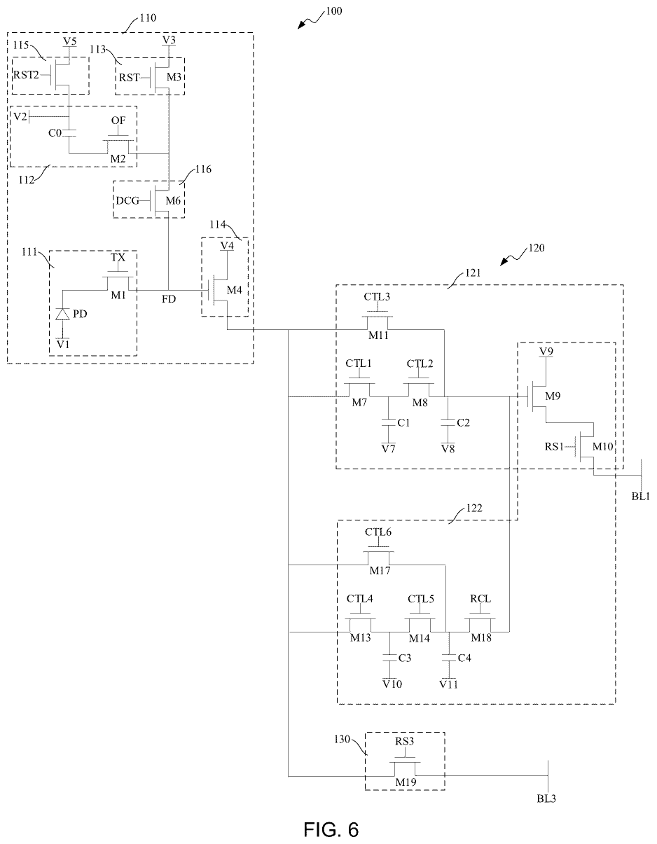

In practical applications, the first storage readout portion 121 and the second storage readout portion 122 may each use a dedicated source-following transistor and row selection transistor as previously described, or they may share a common set of source-following and row selection transistors. For example, the second source-following transistor M9 and the first row selection transistor M10 may be reused; alternatively, the third source-following transistor M15 and the second row selection transistor M160 may also be reused. These alternative implementations are substantially equivalent in function. In order to read out the corresponding signals in an orderly manner, one of the first storage readout portion 121 and the second storage readout portion 122 comprises a readout transistor M18. In the case where the first storage readout portion 121 comprises the readout transistor M18, a control end of the readout transistor M18 receives a readout control signal RCL, a first end of the readout transistor M18 is coupled to the second end of the second storage transistor M8, and a second end of the readout transistor M18 is coupled to the control end of the second source-following transistor M9, as shown in FIG. 5. In the case where the second storage readout portion 122 comprises the readout transistor M18, the control end of the readout transistor M18 receives the readout control signal RCL, the first end of the readout transistor M18 is coupled to the second end of the fifth storage transistor M14, and the second end of the readout transistor M18 is coupled to the control end of the second source-following transistor M9, as shown in FIG. 6.

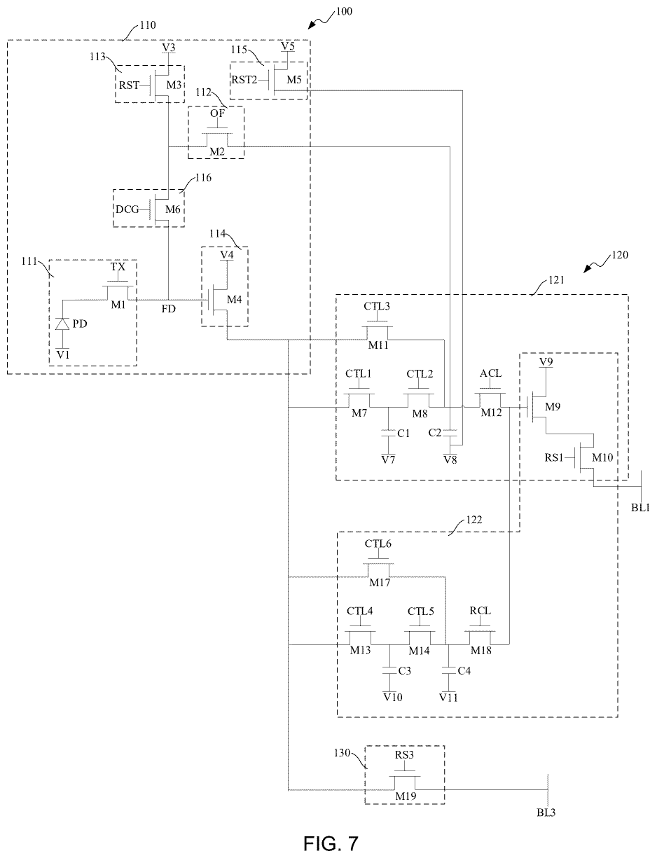

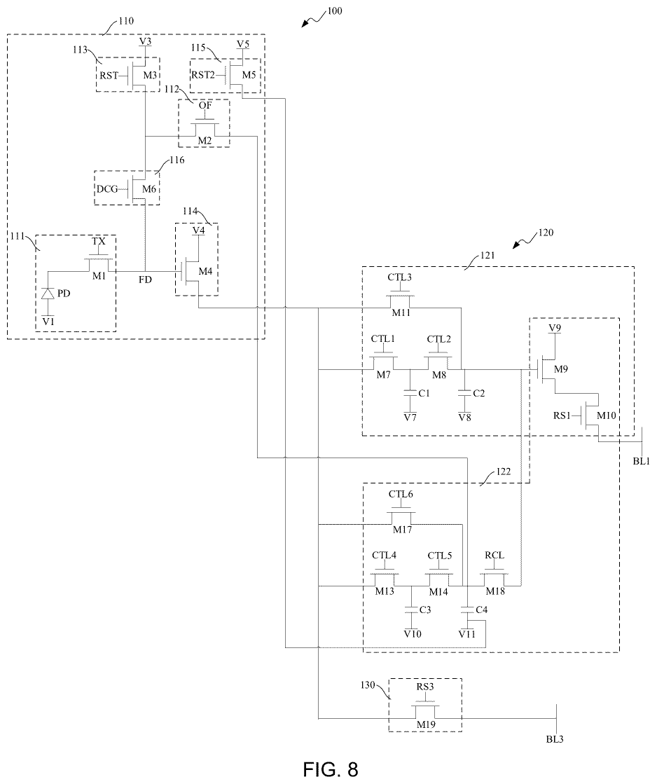

The first storage capacitor C1, the second storage capacitor C2, the third storage capacitor C3, and the fourth storage capacitor C4 are implemented using MIM capacitors. Typically, the capacitance of each storage capacitor is designed to be greater than that of the overflow capacitor C0. As an alternative, the storage capacitors may be designed with equal capacitance values. For the consideration of reducing the circuit area, the overflow portion 112 can be designed to share the first storage capacitor C1 or the second storage capacitor C2 with the first storage readout portion 121, or share the third storage capacitor C3 or the fourth storage capacitor C4 with the second storage readout portion 122. In such cases, the second end of the overflow portion 112 is no longer coupled to the second potential V2 via the overflow capacitor C0, but instead is coupled to the corresponding potential through the shared storage capacitor, as illustrated in FIGS. 7 and 8. The configuration where the third storage capacitor C3 is shared by the overflow portion 112 and the second storage readout portion 122 is similar to the configuration where the first storage capacitor C1 is shared by the overflow portion 112 and the first storage readout portion 121, and the configuration where the fourth storage capacitor C4 is shared by the overflow portion 112 and the second storage readout portion 122 is similar to the configuration where the second storage capacitor C2 is shared by the overflow portion 112 and the first storage readout portion 121. For related details, please refer to the preceding description. Furthermore, in extended designs involving sharing of the second storage capacitor C2 or the fourth storage capacitor C4, when the first storage readout portion 121 or the second storage readout portion 122 comprises the readout transistor M18, and the shared storage capacitor and readout transistor M18 reside within the same storage readout portion, then the auxiliary control transistor M12 is not required, the readout transistor M18 itself can perform the function of the auxiliary control transistor M12. However, when the shared storage capacitor and readout transistor M18 are located in different storage readout portions, the auxiliary control transistor M12 must still be provided. For further details, please refer to the preceding description.

For the above four alternative schemes, when the conversion output module 110 further comprises the second reset portion 115, the coupling of the second reset portion 115 can be adjusted. The coupling configuration of the second reset transistor M5 in the first two alternative schemes can be found in the preceding description. In the latter two alternative schemes, when the third storage capacitor C3 is shared by the second reset portion 115 and the second storage readout portion 122, the second end of the second reset transistor M5 in the second reset portion 115 is no longer coupled to the plate of the overflow capacitor C0 close to the second potential V2, but instead is coupled to the plate of the third storage capacitor C3 close to the tenth potential V10, thereby enabling fast reset of the third storage capacitor C3 by cooperating with the first reset portion 113. Similarly, when the fourth storage capacitor C4 is shared by the second reset portion 115 and the second storage readout portion 122, the second end of the second reset transistor M5 in the second reset portion 115 is no longer coupled to the plate of the overflow capacitor C0 close to the second potential V2, but is instead coupled to the plate of the fourth storage capacitor C4 close to the eleventh potential V11, thereby enabling fast reset of the fourth storage capacitor C4 by cooperating with the first reset portion 113.

The second-mode operation module 130 is connected to the conversion output module 110. In a second mode, the second-mode operation module 130 is configured to read out at least one of the first set of signals and the second set of signals. In one implementation, the second-mode operation module 130 comprises a third row selection transistor M19. A control end of the third row selection transistor M19 receives a third row selection control signal RS3, a first end of the third row selection transistor M19 is coupled to the output of the conversion output module 110 (e.g., to the second end of the first source-following transistor M4 in the output portion 114), and a second end of the third row selection transistor M19 is coupled to a third column line BL3. In practice, the third column line BL3 and the first column line BL1 may be the same column line or different column lines; and in the first-mode operation module 120, the first column line BL1 and the second column line BL2 may be the same column line or different column lines.

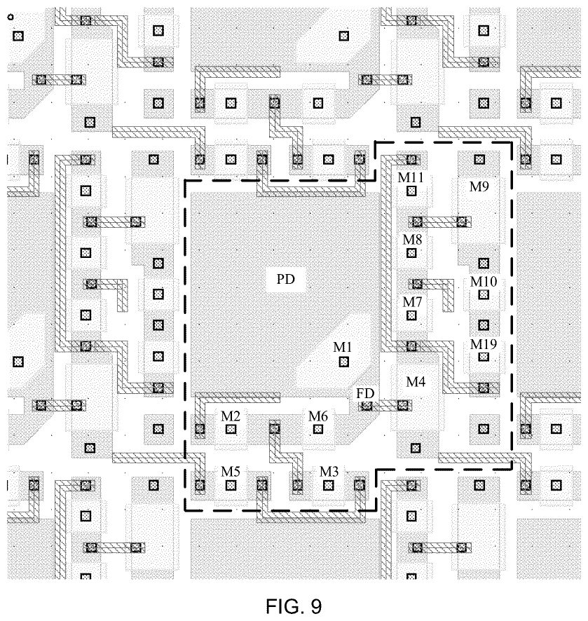

As shown in FIG. 9, the present disclosure further provides an arrangement structure of an image sensor, involving the layout design of the devices within the conversion output module 110, the first-mode operation module 120, and the second-mode operation module 130. The image sensor adopts the circuit architecture described above.

As an example, the conversion output module 110 comprises a photoreceptor portion 111, an overflow portion 112, a first reset portion 113, and an output portion 114. Further, the conversion output module 110 comprises at least one of a second reset portion 115 and a gain portion 116.

The photoreceptor portion 111 comprises a photoreceptor element PD and a transmission transistor M1, both formed in a semiconductor substrate. The photoreceptor element PD has a rectangular shape defined by a first side, a second side, a third side, and a fourth side, and the transmission transistor M1 is positioned in the corner region adjacent to the first and second sides of the photoreceptor element PD. In practice, the transmission transistor M1 is typically positioned in this corner region with a tilt angle, which may be set to 45° as an example.

The overflow portion 112 is positioned close to the first side of the photoreceptor portion 111. In one implementation, the overflow portion 112 comprises an overflow transistor M2 and an overflow capacitor C0. The overflow transistor M2 is formed in the semiconductor substrate and the overflow capacitor C0 is formed in an interconnecting structural layer. It should be noted that the overflow portion 112 is positioned close to the first side of the photoreceptor portion 111, primarily indicating that the overflow transistor M2 within the overflow portion 112 is located close to the first side of the photoreceptor portion 111.

The first reset portion 113 is positioned close to the first side of the photoreceptor portion 111, and the first reset portion 113 and the overflow portion 112 are arranged in a staggered manner. In this context, a horizontal direction of the layouts (for example, FIG. 9) is defined as the first direction, and a vertical direction is defined as the second direction, wherein the horizontal direction and the vertical direction are perpendicular to each other and parallel to the plane of the paper. The term “staggered manner” refers to a configuration in which the projections of the two or more components along the second direction do not overlap, or alternatively, the projections along the first direction do not overlap. In one implementation, the first reset portion 113 comprises a first reset transistor M3 formed in the semiconductor substrate. The first reset transistor M3 and the overflow transistor M2 are arranged in a staggered manner. For example, when the first reset transistor M3 and the overflow transistor M2 are arranged along the first direction and the first reset transistor M3 and the transmission transistor M1 are arranged along the second direction, the first reset transistor M3 is below the transmission transistor M1, while the overflow transistor M2 is positioned close to a left side of the first reset transistor M3.

The output portion 114 is positioned close to the second side of the photoreceptor portion 111. In one implementation, the output portion 114 comprises a first source-following transistor M4 formed in the semiconductor substrate. The first source-following transistor M4 is disposed adjacent to the second side of the photoreceptor element PD.

When the conversion output module 110 further comprises the second reset portion 115, the second reset portion 115 is positioned close to the first side of the photoreceptor portion 111, and the second reset portion 115 is provided in a staggered manner with the overflow portion 112 and the first reset portion 113. For example, the second reset portion 115 and the first reset portion 113 are arranged along the first direction, and the second reset portion 115 and the overflow portion 112 are arranged along the second direction. In one implementation, the second reset portion 115 comprises a second reset transistor M5 formed in the semiconductor substrate. The second reset transistor M5 and the first reset transistor M3 are arranged along the first direction and the second reset transistor M5 and the overflow transistor M2 are arranged along the second direction, at which time, the second reset transistor M5 is positioned close to the left side of the first reset transistor M3 and is below the overflow transistor M2. This facilitates the common connection of M3 and M5, and also facilitates the connection between M3 and M2 as well as between M5 and M2, thereby enabling rapid reset of the overflow portion 112.

When the conversion output module 110 comprises the gain portion 116, the gain portion 116 is positioned close to the first side of the photoreceptor portion 111, and the gain portion 116 is provided in a staggered manner with the overflow portion 112, the first reset portion 113, and the second reset portion 115. As an example, the gain portion 116 and the overflow portion 112 are arranged along the first direction, and the gain portion 116 and the first reset portion 113 are arranged along the second direction. This is conducive to optimizing the layout design, enhancing the flexibility of layout design, and better accommodating pixel size scaling and the continuously shrinking layout design. In one implementation, the gain portion 116 comprises a gain transistor M6 formed in the semiconductor substrate. The gain transistor M6 and the overflow transistor M2 are arranged along the first direction, and the gain transistor M6 and the first reset transistor M3 are arranged along the second direction, at which time, the gain transistor M6 is positioned close to a right side of the overflow transistor M2 and is above the first reset transistor M3. This facilitates improving the flexibility of circuit connection of M6, facilitates enabling the operation of the floating diffusion node FD with M2 and M3 respectively via M6, and facilitates improving the quality of imaging signals.

As an example, the first-mode operation module 120 comprises a first storage readout portion 121. As another example, the first-mode operation module 120 further comprises a second storage readout portion 122.

The first storage readout portion 121 is positioned close to the second side of the photoreceptor portion 111. In one implementation, the first storage readout portion 121 comprises a first storage transistor M7, a second storage transistor M8, a first storage capacitor C1, a second storage capacitor C2, a second source-following transistor M9, and a first row selection transistor M10. The first storage readout portion 121 may further comprise a third storage transistor M11. Each of the above transistors is formed in the semiconductor substrate, and each of the above capacitors is formed in the interconnecting structural layer. It should be noted that the first storage readout portion 121 is positioned close to the second side of the photoreceptor portion 111, primarily indicating that the transistors of the first storage readout portion 121 are located close to the second side of the first storage readout portion 121. For example, the first storage transistor M7, the second storage transistor M8, and the third storage transistor M11 are arranged along the second direction together with the first source-following transistor M4. The second source-following transistor M9 and the first row selection transistor M10 are arranged along the second direction and are positioned close to the side of the above transistors that is away from the photoreceptor element PD, in parallel with the transistors. The first storage transistor M7 is above the first source-following transistor M4, the second storage transistor M8 is above the first storage transistor M7, the third storage transistor M11 is above the second storage transistor M8, the second source-following transistor M9 is positioned close to a right side of the third storage transistor M11, and the first row selection transistor M10 is below the second source-following transistor M9.

As an example, the first-mode operation module 120 further comprises the second storage readout portion 122, and the second storage readout portion 122 is positioned close to the second side of the photoreceptor portion 111. In one implementation, the second storage readout portion 122 comprises a fourth storage transistor M13, a fifth storage transistor M14, a third storage capacitor C3, a fourth storage capacitor C4, a third source-following transistor M15, and a second row selection transistor M16. The second storage readout portion 122 may further comprise a sixth storage transistor M17. Each of the above transistors is formed in the semiconductor substrate, and each of the above capacitors is formed in the interconnecting structural layer. For the consideration of reducing the circuit area, the first storage readout portion 121 and the second storage readout portion 122 may share a common set of source-following and row selection transistors. In this configuration, the second storage readout portion 122 is positioned close to the second side of the photoreceptor portion 111, primarily indicating that the fourth storage transistor M13, the fifth storage transistor M14, and the sixth storage transistor M17 are located close to the second side of the photoreceptor portion 11. For example, the fourth storage transistor M13, the fifth storage transistor M14, and the sixth storage transistor M17 are arranged along the second direction and are disposed between the third storage transistor M11 and the second source-following transistor M9. The fourth storage transistor M13, the fifth storage transistor M14, and the sixth storage transistor M17 may be disposed in a bottom-to-top sequence.

The second-mode operation module 130 is positioned close to the second side of the photoreceptor portion 111. In one implementation, the second-mode operation module 130 comprises a third row selection transistor M19 formed in the semiconductor substrate. The third row selection transistor M19 is arranged along the second direction together with the second source-following transistor M9 and the first row selection transistor M10. For example, the third row selection transistor M19 is below the first row selection transistor M10.

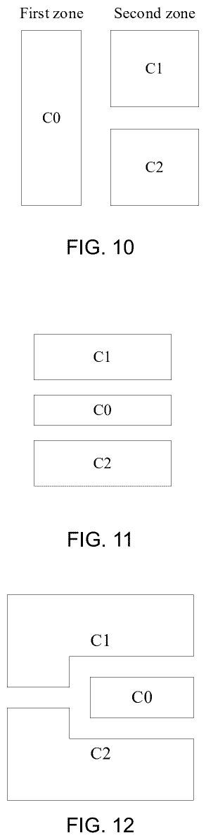

The interconnecting structural layer is formed on the semiconductor substrate and may consist of a single layer or multiple layers. In practical applications, each capacitor may be formed within a separate interconnecting structural layer, or at least two capacitors may be formed within the same interconnecting structural layer. However, it is common for all capacitors to be formed within a single interconnecting structural layer. In addition, in the layout, the area of each storage capacitor is typically designed to be larger than that of the overflow capacitor. Furthermore, the storage capacitors may be designed with equal areas. The layout of these capacitors can be referenced in FIGS. 10 to 14. Specifically, in one implementation, the overflow capacitor C0 in the conversion output module 110 and the storage capacitors are respectively disposed in a first zone and a second zone adjacent to the first zone, and along a connection direction, a projection of each of the storage capacitors falls within a projection of the capacitor in the conversion output module 110, as shown in FIG. 10. The connection direction is perpendicular to a border between the first zone and the second zone; in another implementation, the storage capacitors are arranged symmetrically with respect to the overflow capacitor C0, as illustrated in FIG. 11; in other implementations, the each storage capacitor has a recessed portion, and the recessed portions of different storage capacitors are arranged opposite to one another to form a recessed region, within which the overflow capacitor C0 is positioned, as shown in FIGS. 12 to 14. Other layout configurations are also feasible and the examples described herein are not exhaustive.

The present disclosure further provides a method for controlling an image sensor comprising a first mode and a second mode. The image sensor is realized using a circuit structure as described above. In practice, the first mode is typically a global shutter mode, while the second mode is generally a rolling shutter mode. During actual operation, the desired mode may be selected based on specific requirements.

In the first mode, an operation of storing and then reading out at least one of the first set of signals and the second set of signals is performed based on the conversion output module 110 and the first-mode operation module 120; and in the second mode, an operation of reading out at least one of the first set of signals and the second set of signals is performed based on the conversion output module 110 and the second-mode operation module 130.

As an example, the first mode and the second mode operate independently, and the image sensor is configured to:
in the first mode: activate the conversion output module 110 and the first-mode operation module 120 and deactivate the second-mode operation module 130, to store and read out at least one of the first set of signals and the second set of signals; for example, either the first reset signal and the pixel signal, or the second reset signal and the overflow signal, may be selected for storage and readout during a reset phase, an exposure phase, a transfer storage phase, and a readout phase.

When the operation involves storing and reading out the first reset signal and the pixel signal, the corresponding actions performed during each phase, as exemplified in FIG. 1, are as follows: in the reset phase: at least the transmission transistor M1, the first reset transistor M3, and the gain transistor M6 are controlled to turn on, and the reset operation is performed for at least the FD node and the photoreceptor element PD by the first reset transistor M3, and then at least the transmission transistor M1 is controlled to turn off; optionally, the gain transistor M6 may also be turned off; in the exposure phase: the photoreceptor element PD performs accumulation of photogenerated electrons based on photoelectric effect; in the transfer storage phase: at least the first storage transistor M7 and the third storage transistor M11 are controlled to turn on; the first storage capacitor C1 and the second storage capacitor C2 are reset prior to transfer storage; subsequently, the first storage transistor M7 is controlled to turn off; the first reset signal is then stored in the second storage capacitor C2 by turning on the first source-following transistor M4 and the third storage transistor M11; the third storage transistor M11 is then controlled to turn off; thereafter, the transmission transistor M1 is controlled to turn off following conduction, enabling the transfer of photogenerated electrons to the FD node; the first storage transistor M7 is then controlled to turn off after conduction, resulting in the pixel signal being stored in the first storage capacitor C1; in the readout phase: the first row selection transistor M10 is controlled to turn on, and a readout operation is performed on the first reset signal, and then the second storage transistor M8 is controlled to turn on, and a readout operation is performed on the pixel signal, after which, the correlation double sampling of the pixel signal is completed.

When the conversion output module 110 comprises the gain portion 116, while the first-mode operation module 120 comprises only the first storage readout portion 121, the conversion output module 110 outputs the first reset signal and the pixel signal corresponding to the gain portion 116 under any one of the first conversion gain and the second conversion gain, and the first-mode operation module 120 stores and reads out the first reset signal and the pixel signal under the corresponding conversion gain. When the conversion output module 110 comprises the gain portion 116, and the first-mode operation module 120 comprises both the first storage readout portion 121 and the second storage readout portion 122, in the first mode, the conversion output module 110 outputs the first reset signal and the pixel signal under the first conversion gain and the second conversion gain, respectively, and the first-mode operation module 120 stores and reads out the first reset signal and the pixel signal under the first conversion gain and the second conversion gain by corresponding storage readout portions.

The operations for storing and reading out the first reset signal and the pixel signal under any one of the first conversion gain and the second conversion gain are substantially identical to those described above. The following description focuses on the operations for storing and reading out the first reset signal and the pixel signal under different conversion gains. Using FIG. 4 as an example, the actions performed in each phase are as follows: in the reset phase: at least the transmission transistor M1, the first reset transistor M3, and the gain transistor M6 are controlled to turn on, and the reset operation is performed for at least the FD node and the photoreceptor element PD by the first reset transistor M3, and then at least the transmission transistor M1 is controlled to turn off; in the exposure phase: the photoreceptor element PD performs the accumulation of the photogenerated electrons based on the photoelectric effect; in the transfer storage phase: at least the first storage transistor M7, the third storage transistor M11, the fourth storage transistor M13, and the sixth storage transistor M17 are controlled to turn on; the first storage capacitor C1, the second storage capacitor C2, the third storage capacitor C3, and the fourth storage capacitor C4 are reset prior to transfer storage; subsequently, the first storage transistor M7, the fourth storage transistor M13, and the sixth storage transistor M17 are controlled to turn off; the image sensor operates at the first conversion gain by turning on the gain transistor M6, and the first reset signal under the first conversion gain is then stored in the second storage capacitor C2 by turning on the first source-following transistor M4 and the third storage transistor M11; the gain transistor M6 and the third storage transistor M11 are then controlled to turn off, optionally, the first reset transistor M3 are controlled to turned off, thereby configuring the image sensor to operate at the second conversion gain; the first reset signal under the second conversion gain is then stored in the fourth storage capacitor C4 by controlling the sixth storage transistor M17 to turn off after conduction; thereafter, the transmission transistor M1 is controlled to turn off following conduction, enabling the transfer of the photogenerated electrons to the FD node; the fourth storage transistor M13 is then controlled to turn off after conduction, resulting in the pixel signal under the second conversion gain being stored in the third storage capacitor C3; the gain transistor M6 is then controlled to turn on, thereby configuring the image sensor to switch back to the first conversion gain; the transmission transistor M1 is controlled to turn off following conduction, enabling the transfer of the photogenerated electrons to the FD node; finally, the first storage transistor M7 is controlled to turn off after conduction, resulting in the pixel signal under the first conversion gain being stored in the first storage capacitor C1; in the readout phase: the first row selection transistor M10 is controlled to turn on, and the readout operation is performed on the first reset signal under the first conversion gain, and then the second storage transistor M8 is controlled to turn on, and the readout operation is performed on the pixel signal under the first conversion gain; subsequently, the second row selection transistor M16 is controlled to turn on, and the readout operation is performed on the first reset signal under the second conversion gain, and then the fifth storage transistor M14 is controlled to turn on, and the readout operation is performed on the pixel signal under the second conversion gain, after which, the correlation double sampling of the pixel signal under different conversion gains is completed.

When the first-mode operation module 120 comprises only the first storage readout portion 121, and the overflow portion 112 shares the first storage capacitor C1 with the first storage readout portion 121, in the operation of storing and reading out the second reset signal and the overflow signal, the overflow signal is transferred and stored based on the second storage capacitor C2 (i.e., the overflow signal stored in the first storage capacitor C1 is transferred and stored into the second storage capacitor C2) and the second reset signal is transferred and stored based on the first storage capacitor C1, thereby performing a non-true correlation double sampling of the overflow signal; when the first-mode operation module 120 comprises only the first storage readout portion 121, and the overflow portion 112 shares the second storage capacitor C2 with the first storage readout portion 121, in the operation of storing and reading out the second reset signal and the overflow signal, the overflow signal is stored in the second storage capacitor C2 and the second reset signal is stored in the first storage capacitor C1, and the second reset signal is transferred and stored based on the second storage capacitor C2 after the overflow signal has been read out, thereby performing a non-true correlation double sampling of the overflow signal. Specifically, the respective operations of storing and subsequently reading out the second reset signal and the overflow signal comprise the reset phase, the exposure phase, the transfer storage phase, and the readout phase.

In the configuration where the first storage capacitor C1 is shared by the overflow portion 112 and the first storage readout portion 121, the corresponding actions performed during each phase, as exemplified in FIG. 2, are as follows: in the reset phase: at least the transmission transistor M1, the overflow transistor M2, the first reset transistor M3 and the gain transistor M6 are controlled to turn on, and the reset operation is performed for at least the FD node, the photoreceptor element PD and the first storage capacitor C1 by the first reset transistor M3, and then at least the transmission transistor M1 is controlled to turn off; in the exposure phase: the photoreceptor element PD performs the accumulation of the photogenerated electrons based on the photoelectric effect; a part of the photogenerated electrons overflowing from the photoreceptor element PD is stored in the first storage capacitor C1 through the FD node, the gain transistor M6, and the overflow transistor M2, and the overflow transistor M2 is then controlled to turn off; in the transfer storage phase: the part of the photogenerated electrons stored in the first storage capacitor C1 is transferred to the second storage capacitor C2 by controlling the second storage transistor M8 to turn off following conduction, and then the second reset signal is stored in the first storage capacitor C1 by controlling the first storage transistor M7 to turn off following conduction; in the readout phase: the first row selection transistor M10 is controlled to turn on, and the readout operation is performed on the overflow signal, and then the second storage transistor M8 is controlled to turn on, and the readout operation is performed on the second reset signal, after which, the non-true correlation double sampling of the overflow signal is completed.

In the configuration where the second storage capacitor C2 is shared by the overflow portion 112 and the first storage readout portion 121, the corresponding actions performed during each phase, as exemplified in FIG. 3, are as follows: in the reset phase: at least the transmission transistor M1, the overflow transistor M2, the first reset transistor M3 and the gain transistor M6 are controlled to turn on, and the reset operation is performed for at least the FD node, the photoreceptor element PD and the second storage capacitor C2 by the first reset transistor M3, and then at least the transmission transistor M1 is controlled to turn off; in the exposure phase: the photoreceptor element PD performs the accumulation of the photogenerated electrons based on the photoelectric effect; the part of the photogenerated electrons overflowing from the photoreceptor element PD is stored in the second storage capacitor C2 through the FD node, the gain transistor M6, and the overflow transistor M2, and the overflow transistor M2 is then controlled to turn off; in the transfer storage phase: the second reset signal is stored in the first storage capacitor C1 by controlling the first storage transistor M7 to turn off following conduction; in the readout phase: the first row selection transistor M10 and the auxiliary control transistor M12 are controlled to turn on, and the readout operation is performed on the overflow signal, and then the second storage transistor M8 is controlled to turn on, and the readout operation is performed on the second reset signal, after which, the non-true correlation double sampling of the overflow signal is completed.

When the first-mode operation module 120 comprises both the first storage readout portion 121 and the second storage readout portion 122, and the overflow portion 112 shares the third storage capacitor C3 with the second storage readout portion 122, the operation of storing and reading out the second reset signal and the overflow signal corresponds to the case in which the first storage capacitor C1 is shared by the overflow portion 112 and the first storage readout portion 121; when the first-mode operation module 120 comprises both the first storage readout portion 121 and the second storage readout portion 122, and the overflow portion 112 shares the fourth storage capacitor C4 with the second storage readout portion 122, the operation of storing and reading out the second reset signal and the overflow signal corresponds to the case in which the second storage capacitor C2 is shared by the overflow portion 112 and the first storage readout portion 121. Specifically, the respective operations of storing and subsequently reading out the second reset signal and the overflow signal comprise the reset phase, the exposure phase, the transfer storage phase, and the readout phase. The case where the third storage capacitor C3 is shared by the overflow portion 112 and the second storage readout portion 122 corresponds to the case in which the first storage capacitor C1 is shared by the overflow portion 112 and the first storage readout portion 121; likewise, the case where the fourth storage capacitor C4 is shared by the overflow portion 112 and the second storage readout portion 122 corresponds to the case in which the second storage capacitor C2 is shared by the overflow portion 112 and the first storage readout portion 121. For related details, please refer to the preceding description.

In the second mode, the image sensor is configured to: activate the conversion output module 110 and the second-mode operation module 130 and deactivate the first-mode operation module 120, to read out the first set of signals and the second set of signals; for example, either the first reset signal and the pixel signal, or the second reset signal and the overflow signal, may be selected for readout during the reset phase, the exposure phase, the transfer storage phase, and the readout phase.

The corresponding actions performed during each phase, as exemplified in FIG. 1, are as follows: in the reset phase: at least the transmission transistor M1, the overflow transistor M2, the first reset transistor M3, the second reset transistor M5, and the gain transistor M6 are controlled to turn on, and the reset operation is performed on the FD node and the photoreceptor element PD by the first reset transistor M3; subsequently, the reset operation is performed on the overflow capacitor C0 through the cooperation of the first reset transistor M3 and the second reset transistor M5; thereafter, the transmission transistor M1, the first reset transistor M3, and the second reset transistor M5 are controlled to turn off; in the exposure phase: the photoreceptor element PD performs the accumulation of the photogenerated electrons based on the photoelectric effect; the part of the photogenerated electrons overflowing from the photoreceptor element PD is stored in the overflow capacitor C0 through the FD node, the gain transistor M6, and the overflow transistor M2, and the overflow transistor M2 is then controlled to turn off; in the readout phase: the readout operation is performed on the first reset signal by controlling the third row selection transistor M19 to turn off after conduction, the photogenerated electrons are then transferred to the FD node by controlling the transmission transistor M1 to turn off after conduction; subsequently, the readout operation is performed on the pixel signal by again controlling the third row selection transistor M19 to turn off after conduction; thereafter, the readout operation is performed on the overflow signal by controlling the overflow transistor M2 to turn off after conduction; the reset operation is performed on the FD node by controlling first reset transistor M3 to turn off after conduction, and the readout operation is then performed on the second reset signal by controlling the third row selection transistor M19 to turn off after conduction, after which, the correlation double sampling of the pixel signal and the non-true correlation double sampling of the overflow signal are successively completed. The third row selection transistor M19 may alternatively be maintained in a conductive state throughout the readout phase. In other examples, the reset operation of the FD node and the readout operation of the second reset signal may also be performed prior to reading out the overflow signal, thereby completing the correlation double sampling of the overflow signal.

When the conversion output module 110 comprises the gain portion 116 and the gain portion 116 performs conversion gain switching, in the second mode, the conversion output module 110 outputs the first reset signal and the pixel signal under the different conversion gains and outputs the second reset signal and the overflow signal under any of the conversion gains (e.g., the second reset signal and the overflow signal under the first conversion gain), at which time, the second-mode operation module performs the readout operation of the first reset signal and the pixel signal under different conversion gains, as well as the readout operation of the second reset signal and the overflow signal under the first conversion gain.

The corresponding actions performed during each phase, as exemplified in FIG. 4, are as follows: in the reset phase: at least the transmission transistor M1, the overflow transistor M2, the first reset transistor M3, the second reset transistor M5, and the gain transistor M6 are controlled to turn on, and the reset operation is performed on the FD node and the photoreceptor element PD by the first reset transistor M3; subsequently, the reset operation is performed on the overflow capacitor C0 through the cooperation of the first reset transistor M3 and the second reset transistor M5; thereafter, the transmission transistor M1, the first reset transistor M3, and the second reset transistor M5 are controlled to turn off; in the exposure phase: the photoreceptor element PD performs the accumulation of the photogenerated electrons based on the photoelectric effect; the part of the photogenerated electrons overflowing from the photoreceptor element PD is stored in the overflow capacitor C0 through the FD node, the gain transistor M6, and the overflow transistor M2, and the overflow transistor M2 is then controlled to turn off; in the readout phase: the image sensor operates at the first conversion gain by turning on the gain transistor M6, and the readout operation is performed on the first reset signal under the first conversion gain by controlling the third row selection transistor M19 to turn on; subsequently, the gain transistor M6 is then controlled to turn off, thereby configuring the image sensor to operate at the second conversion gain; then, the readout operation is performed on the first reset signal under the second conversion gain and the third row selection transistor M19 is controlled to turn off; thereafter, the transmission transistor M1 is controlled to turn off following conduction, enabling the transfer of the photogenerated electrons to the FD node; the third row selection transistor M19 is then controlled to turn on, resulting in the pixel signal under the second conversion gain being read out; the gain transistor M6 is then controlled to turn on, configuring the image sensor to switch back to the first conversion gain, thereby allowing the readout operation of the pixel signal under the first conversion gain; finally, the readout operation is performed on the overflow signal under the first conversion gain by controlling the overflow transistor M2 to turn off after conduction; the reset operation is performed on the FD node by controlling the first reset transistor M3 to turn off after conduction, and the readout operation is then performed on the second reset signal under the first conversion gain by controlling the third row selection transistor M19 to turn off after conduction, after which, the correlation double sampling of the pixel signal under different conversion gains and the non-true correlation double sampling of the overflow signal under the first conversion gain are successively completed. In other examples, the reset operation of the FD node and the readout operation of the second reset signal under the first conversion gain may also be performed prior to reading out the overflow signal under the first conversion gain, thereby completing the correlation double sampling of the overflow signal under the first conversion gain.

In scenarios involving capacitor-sharing configurations,, that is, when the overflow portion 112 shares either the first storage capacitor C1 or the second storage capacitor C2 with the first storage readout portion 121, or shares either the third storage capacitor C3 or the fourth storage capacitor C4 with the second storage readout portion 122, the corresponding storage transistor must also be controlled to conduct in order to enable readout of the overflow signal using the second-mode operation module 130.

Additionally, in such capacitor-sharing configurations, especially when the overflow portion 112 shares the first storage capacitor C1 with the first storage readout portion 121, or shares the third storage capacitor C3 with the second storage readout portion 122, the overflow signal may alternatively be read out using the first-mode operation module 120 instead of the second-mode operation module 130, thereby enabling at least one of correlation double sampling and non-true correlation double sampling of the overflow signal.

In the case where the first storage capacitor C1 is shared by the overflow portion 112 and the first storage readout portion 121, during the readout operation of the second set of signals under the second mode, the first-mode operation module 120 may operate in place of the second-mode operation module 130. That is, the first-mode operation module 120 is active while the second-mode operation module 130 remains inactive. In this configuration, the non-true correlation double sampling of the second set of signals may be performed based on the first storage capacitor C1. Specifically, the overflow signal stored in the first storage capacitor C1 is first transferred to the second storage capacitor C2, followed by transfer of the second reset signal to the first storage capacitor C1. Both the overflow signal and the second reset signal are then read out to complete the non-true correlation double sampling. Alternatively, the correlation double sampling of the second set of signals may be performed based on the second storage capacitor C2. Specifically, the overflow signal is stored in the first storage capacitor C1, the second reset signal is acquired using the second storage capacitor C2 and the third storage transistor M11, and after the second reset signal is read out, the overflow signal is transferred to and read out from the second storage capacitor C2, thereby completing the true correlation double sampling of the overflow signal.

Similarly, in the case where the third storage capacitor C3 is shared by the overflow portion 112 and the second storage readout portion 122, during the readout operation of the second set of signals under the second mode, the first-mode operation module 120 may operate in place of the second-mode operation module 130. That is, the first-mode operation module 120 is active while the second-mode operation module 130 remains inactive. In this configuration, the non-true correlation double sampling of the second set of signals may be performed based on the third storage capacitor C3. Specifically, the overflow signal stored in the third storage capacitor C3 is first transferred to the fourth storage capacitor C4, followed by transfer of the second reset signal to the third storage capacitor C3. Both the overflow signal and the second reset signal are then read out to complete the non-true correlation double sampling. Alternatively, the correlation double sampling of the second set of signals may be performed based on the fourth storage capacitor C4. Specifically, the overflow signal is stored in the third storage capacitor C3, the second reset signal is acquired using the fourth storage capacitor C4 and the sixth storage transistor M17, and after the second reset signal is read out, the overflow signal is transferred to and read out from the fourth storage capacitor C4, thereby completing the true correlation double sampling of the overflow signal.

As another example, the first mode and the second mode operate in conjunction, and the operations of the image sensor comprise the reset phase, the exposure phase, the transfer storage phase, and the readout phase.

In the reset phase, the reset operation is performed for at least the FD node and the conversion output module 110; in the exposure phase, the conversion output module 110 generates the pixel signal and the overflow signal based on the photoelectric conversion; in the transfer storage phase, the first reset signal is formed based on the conversion output module 110 and the first reset signal is stored to the first-mode operation module 120, and the pixel signal is stored to the first-mode operation module 120 based on the conversion output module 110; in the readout phase, the first reset signal and the pixel signal are read out based on the first-mode operation module 120, the second reset signal are formed based on the conversion output module 110, and the second reset signal and the overflow signal are read out based on the second-mode operation module 130.

In one implementation, after the exposure phase, the overflow signal and the second reset signal under the second mode are first read out in sequence; then, the first reset signal and the pixel signal are transferred and stored; subsequently, the first reset signal and the pixel signal under the first mode are read out in sequence. The corresponding actions performed during each phase, as exemplified in FIG. 1, are as follows: in the reset phase: the transmission transistor M1, the overflow transistor M2, the first reset transistor M3, the first source-following transistor M4, the second reset transistor M5, the gain transistor M6, the first storage transistor M7 and the third storage transistor M11 are controlled to turn on, and the reset operation is performed on the FD node, the photoreceptor element PD, the first storage capacitor C1 and the second storage capacitor C2 by the first reset transistor M3; subsequently, the reset operation is performed on the overflow capacitor C0 through the cooperation of the first reset transistor M3 and the second reset transistor M5; thereafter, the transmission transistor M1, the first reset transistor M3, the second reset transistor M5, the first storage transistor M7 and the third storage transistor M11 are controlled to turn off; in the exposure phase: the photoreceptor element PD performs the accumulation of the photogenerated electrons based on the photoelectric effect; the part of the photogenerated electrons overflowing from the photoreceptor element PD is stored in the overflow capacitor C0 through the FD node, the gain transistor M6, and the overflow transistor M2; in the transfer storage and readout phases: first, the overflow transistor M2 and the gain transistor M6 are controlled to turn on, the third row selection transistor M19 is controlled to turn off following conduction (that is, the third row selection transistor M19 is first placed in an on state and subsequently transitioned to an off state), then the overflow transistor M2 is turned off after the readout operation of the overflow signal, the reset operation is performed on the FD node by controlling the first reset transistor M3 to turn off after conduction, and the readout operation is performed on the second reset signal by controlling the third row selection transistor M19 to turn off after conduction, after which, the non-true correlation double sampling of the overflow signal is completed; furthermore, the first reset signal is transferred and stored into the second storage capacitor C2 by controlling the third storage transistor M11 to turn off after conduction; thereafter, the transmission transistor M1 is controlled to turn off following conduction, enabling the transfer of the photogenerated electrons to the FD node; the first storage transistor M7 is controlled to turn off following conduction, to transfer and store the pixel signal into the first storage capacitor C1; finally, the readout operation is performed on the first reset signal by controlling the first row selection transistor M10 to turn on, and the readout operation is then performed on the pixel signal by controlling the second storage transistor M8 to turn off following conduction, after which, the correlation double sampling of the pixel signal is completed.

In another implementation, after the exposure phase, the first reset signal and the pixel signal are first transferred and stored; then, the first reset signal and the pixel signal under the first mode are read out in sequence; subsequently, the overflow signal and the second reset signal under the second mode are read out in sequence. In addition, the second reset signal may be read out either before or after the overflow signal. The corresponding actions performed during each phase, as exemplified in FIG. 1, are as follows: in the reset phase: the transmission transistor M1, the overflow transistor M2, the first reset transistor M3, the first source-following transistor M4, the second reset transistor M5, the gain transistor M6, the first storage transistor M7 and the third storage transistor M11 are controlled to turn on, and the reset operation is performed on the FD node, the photoreceptor element PD, the first storage capacitor C1 and the second storage capacitor C2 by the first reset transistor M3; subsequently, the reset operation is performed on the overflow capacitor C0 through the cooperation of the first reset transistor M3 and the second reset transistor M5; thereafter, the transmission transistor M1, the first reset transistor M3, the second reset transistor M5, the first storage transistor M7 and the third storage transistor M11 are controlled to turn off; in the exposure phase: the photoreceptor element PD performs the accumulation of the photogenerated electrons based on the photoelectric effect; the part of the photogenerated electrons overflowing from the photoreceptor element PD is stored in the overflow capacitor C0 through the FD node, the gain transistor M6, and the overflow transistor M2, and the overflow transistor M2 is then controlled to turn off; in the transfer storage and readout phases: first, the first reset signal is transferred and stored into the second storage capacitor C2 by controlling the third storage transistor M11 to turn off after conduction; then the transmission transistor M1 is controlled to turn off following conduction, enabling the transfer of the photogenerated electrons to the FD node; the first storage transistor M7 is controlled to turn off following conduction, to transfer and store the pixel signal into the first storage capacitor C1; thereafter, the readout operation is performed on the first reset signal by controlling the first row selection transistor M10 to turn on, and the readout operation is then performed on the pixel signal by controlling the second storage transistor M8 to turn off following conduction, after which, the correlation double sampling of the pixel signal is completed; furthermore, the reset operation is performed on the FD node by controlling the first reset transistor M3 to turn off after conduction, and the readout operation is then performed on the second reset signal by controlling the third row selection transistor M19 to turn off after conduction, finally, the overflow transistor M2 is controlled to turn on and the third row selection transistor M19 is controlled to turn off following conduction, and the readout operation is performed on the overflow signal, after which, the correlation double sampling of the overflow signal is completed. The readout operation of the overflow signal may also be performed prior to resetting the FD node and reading out the second reset signal, at which time, the non-true correlation double sampling is performed on the overflow signal.

When the first-mode operation module 120 comprises both the first storage readout portion 121 and the second storage readout portion 122, in the transfer storage phase, the first reset signal under each of the first and second conversion gains is formed based on the conversion output module 110, the first reset signal under the first conversion gain is stored to the first storage readout portion 121, the first reset signal under the second conversion gain is stored to the second storage readout portion 122, and the conversion output module 110 stores the pixel signal under the first conversion gain to the first storage readout portion 121 and stores the pixel signal under the second conversion gain to the second storage readout portion 122; in the readout phase, the first reset signal and the pixel signal under the different conversion gains are read out based on the first-mode operation module 120, the second reset signal are formed based on the conversion output module 110, and the second reset signal and the overflow signal are read out based on the second-mode operation module 130. In one implementation, after the exposure phase, the overflow signal and the second reset signal in the second mode are first read out in sequence; then, the first reset signal and the pixel signal under the different conversion gains are transferred and stored; subsequently, the first reset signal and the pixel signal under the different conversion gains in the first mode are read out in sequence. In another implementation, after the exposure phase, the first reset signal and the pixel signal under the different conversion gains are first transferred and stored; then, the first reset signal and the pixel signal under the different conversion gains in the first mode are read out; subsequently, the overflow signal and the second reset signal in the second mode are read out. In addition, the second reset signal may be read out either before or after the overflow signal.

As described above, the image sensor, the arrangement structure, and the control method of the present disclosure enable switching between the first mode and the second mode within a single image sensor through the design of the conversion output module, the first-mode operation module, and the second-mode operation module, thereby eliminating the need to switch between different image sensors to achieve mode transition. Therefore, the present disclosure effectively overcomes various shortcomings in the existing technology and has high industrial utilization value.

The above-mentioned embodiments are for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the scope of the present disclosure.

1. An image sensor, comprising pixel units arranged in an array, wherein each of the pixel units comprises:
a conversion output module, configured to output a first set of signals comprising a first reset signal and a pixel signal, and output a second set of signals comprising a second reset signal and an overflow signal;
a first-mode operation module, connected to the conversion output module, wherein in a first mode, the first-mode operation module is configured to store and read out at least one of the first set of signals and the second set of signals; and
a second-mode operation module, connected to the conversion output module, wherein in a second mode, the second-mode operation module is configured to read out at least one of the first set of signals and the second set of signals.

2. The image sensor according to claim 1, wherein the conversion output module comprises:
a photoreceptor portion, coupled to a floating diffusion node, wherein the photoreceptor portion is configured to perform accumulation of photogenerated electrons based on photoelectric effect, and transfer the photogenerated electrons at least to the floating diffusion node, to read out the pixel signal;
an overflow portion, coupled to the floating diffusion node or the photoreceptor portion, wherein the overflow portion is configured to store a part of the photogenerated electrons overflowing from the floating diffusion node or the photoreceptor portion, to read out the overflow signal;
a first reset portion, coupled to the floating diffusion node, wherein the first reset portion is configured to reset at least the floating diffusion node, to read out a corresponding one of the first reset signal and the second reset signal; and
an output portion, coupled to the floating diffusion node, for amplifying a corresponding one of the first set of signals and the second set of signals.

3. The image sensor according to claim 2, wherein the photoreceptor portion comprises a transmission transistor and a photoreceptor element, wherein a control end of the transmission transistor receives a transmission control signal, a first end of the transmission transistor is coupled to the floating diffusion node, and a second end of the transmission transistor is coupled to a first potential through the photoreceptor element;
and/or, wherein the overflow portion comprises an overflow transistor and an overflow capacitor, wherein a control end of the overflow transistor receives an overflow control signal, a first end of the overflow transistor is coupled to the floating diffusion node or the photoreceptor portion, and a second end of the overflow transistor is coupled to a second potential through the overflow capacitor;
and/or, wherein the first reset portion comprises a first reset transistor, wherein a control end of the first reset transistor receives a first reset control signal, a first end of the first reset transistor is coupled to a third potential, and a second end of the first reset transistor is coupled to the floating diffusion node;
and/or, wherein the output portion comprises a first source-following transistor, wherein a control end of the first source-following transistor is coupled to the floating diffusion node, a first end of the first source-following transistor is coupled to a fourth potential, and a second end of the first source-following transistor serves as an output of the conversion output module.

4. The image sensor according to claim 2, wherein the conversion output module further comprises:
a second reset portion, coupled to the overflow portion, for resetting at least the overflow portion; and/or
a gain portion, coupled to the floating diffusion node, for switching between conversion gains.

5. The image sensor according to claim 4, wherein the conversion output module comprises the second reset portion and the second reset portion comprises a second reset transistor, wherein a control end of the second reset transistor receives a second reset control signal, a first end of the second reset transistor is coupled to a fifth potential, and a second end of the second reset transistor is coupled to the overflow portion; wherein the second reset portion resets the overflow portion by cooperating with the first reset portion;
wherein the conversion output module comprises the gain portion and the gain portion comprises a gain transistor, wherein the gain transistor is coupled between the first reset portion and the floating diffusion node, or a first end of the gain transistor is coupled to the floating diffusion node and a second end of the gain transistor is coupled to a sixth potential; wherein a control end of the gain transistor receives a gain control signal.

6. The image sensor according to claim 1, wherein the second-mode operation module comprises a third row selection transistor, wherein a control end of the third row selection transistor receives a third row selection control signal, a first end of the third row selection transistor is coupled to the output of the conversion output module, and a second end of the third row selection transistor is coupled to a third column line.

7. The image sensor according to claim 1, wherein the first-mode operation module comprises a first storage readout portion; wherein the conversion output module comprises a gain portion, the first storage readout portion is configured to store and read out the first reset signal and the pixel signal corresponding to the gain portion under any one of a first conversion gain and a second conversion gain, or the first-mode operation module further comprises a second storage readout portion, the first storage readout portion is configured to store and read out the first reset signal and the pixel signal corresponding to the gain portion under the first conversion gain, and the second storage readout portion is configured to store and read out the first reset signal and the pixel signal corresponding to the gain portion under the second conversion gain.

8. The image sensor according to claim 7, wherein the first storage readout portion comprises a first storage transistor, a second storage transistor, a first storage capacitor, a second storage capacitor, a second source-following transistor, and a first row selection transistor; wherein a control end of the first storage transistor receives a first storage control signal, a first end of the first storage transistor is coupled to an output of the conversion output module, and a second end of the first storage transistor is coupled to a seventh potential through the first storage capacitor, and is further coupled to a first end of the second storage transistor, wherein a control end of the second storage transistor receives a second storage control signal, and a second end of the second storage transistor is coupled to an eighth potential through the second storage capacitor, and is further coupled to a control end of the second source-following transistor, wherein a first end of the second source-following transistor is coupled to a ninth potential, and a second end of the second source-following transistor is coupled to a first end of the first row selection transistor, wherein a control end of the first row selection transistor receives a first row selection control signal, and a second end of the first row selection transistor is coupled to a first column line; or wherein the first storage readout portion further comprises a third storage transistor, wherein a control end of the third storage transistor receives a third storage control signal, a first end of the third storage transistor is coupled to the first end of the first storage transistor, and a second end of the third storage transistor is coupled to the second end of the second storage transistor;
wherein the first-mode operation module comprises the second storage readout portion and the second storage readout portion comprises a fourth storage transistor, a fifth storage transistor, a third storage capacitor, a fourth storage capacitor, a third source-following transistor, and a second row selection transistor, a control end of the fourth storage transistor receives a fourth storage control signal, a first end of the fourth storage transistor is coupled to the output of the conversion output module, and a second end of the fourth storage transistor is coupled to a tenth potential through the third storage capacitor, and is further coupled to a first end of the fifth storage transistor, wherein a control end of the fifth storage transistor receives a fifth storage control signal, and a second end of the fifth storage transistor is coupled to an eleventh potential through the fourth storage capacitor, and is further coupled to a control end of the third source-following transistor, wherein a first end of the third source-following transistor is coupled to a twelfth potential, and a second end of the third source-following transistor is coupled to a first end of the second row selection transistor, wherein a control end of the second row selection transistor receives a second row selection control signal, and a second end of the second row selection transistor is coupled to a second column line; or wherein the second storage readout portion further comprises a sixth storage transistor, wherein a control end of the sixth storage transistor receives a sixth storage control signal, a first end of the sixth storage transistor is coupled to the first end of the fourth storage transistor, and a second end of the sixth storage transistor is coupled to the second end of the fifth storage transistor.

9. The image sensor according to claim 8, wherein the first-mode operation module comprises the second storage readout portion and the second storage readout portion shares the second source-following transistor and the first row selection transistor with the first storage readout portion, one of the first storage readout portion and the second storage readout portion comprises a readout transistor, wherein a control end of the readout transistor receives a readout control signal, a first end of the readout transistor is coupled to the second end of the second storage transistor or the second end of the fifth storage transistor, and a second end of the readout transistor is coupled to the control end of the second source-following transistor.

10. The image sensor according to claim 8, wherein the conversion output module comprises an overflow portion and the overflow portion comprises an overflow capacitor, the storage capacitors in the first-mode operation module and the overflow capacitor in the conversion output module are configured as MIM capacitors, and a capacitance of each of the storage capacitors in the first-mode operation module is larger than a capacitance of the overflow capacitor.

11. The image sensor according to claim 7, wherein the conversion output module comprises an overflow portion and the overflow portion comprises an overflow transistor, the overflow portion shares either a first storage capacitor or a second storage capacitor with the first storage readout portion; wherein the first-mode operation module comprises the second storage readout portion and the second storage readout portion comprises a third storage capacitor or a fourth storage capacitor, the overflow portion shares a corresponding one of the storage capacitors with either the first storage readout portion or the second storage readout portion; wherein a second end of the overflow transistor is coupled to the multiplexed storage capacitor;
or, the overflow portion shares either the second storage capacitor with the first storage readout portion or the fourth storage capacitor with the second storage readout portion, an auxiliary control transistor is coupled between the multiplexed storage capacitor and a corresponding source-following transistor, and a control end of the auxiliary control transistor receives an auxiliary control signal.

12. An arrangement structure for the image sensor according to claim 1, wherein
the conversion output module comprises a photoreceptor portion, an overflow portion, a first reset portion and an output portion, the overflow portion and the first reset portion are disposed close to a first side of the photoreceptor portion, and the output portion is disposed close to a second side of the photoreceptor portion, wherein the overflow portion and the first reset portion are arranged in a staggered manner;
the first-mode operation module comprises a first storage readout portion disposed close to the second side of the photoreceptor portion;
the second-mode operation module is disposed close to the second side of the photoreceptor portion.

13. The arrangement structure for the image sensor according to claim 12, wherein the conversion output module further comprises a second reset portion and/or a gain portion, and the second reset portion and the gain portion are disposed close to the first side of the photoreceptor portion, wherein the second reset portion and the first reset portion are arranged along a first direction, and the second reset portion and the overflow portion are arranged along a second direction, wherein the gain portion and the overflow portion are arranged along the first direction, and the gain portion and the first reset portion are arranged along the second direction;
and/or, wherein the first-mode operation module further comprises a second storage readout portion disposed close to the second side of the photoreceptor portion.

14. The arrangement structure for the image sensor according to claim 12, wherein the photoreceptor portion comprises a photoreceptor element, transistors in the conversion output module, the first-mode operation module and the second-mode operation module and the photoreceptor element are formed in a semiconductor substrate, capacitors in the conversion output module and the first-mode operation module are formed in one or more interconnecting structural layers, and the interconnecting structural layers are formed over the semiconductor substrate.

15. The arrangement structure for the image sensor according to claim 14, wherein the capacitors in the conversion output module and the first-mode operation module are formed in a same interconnecting structural layer; and/or, an area of each of the capacitors in the first-mode operation module is larger than an area of the capacitor in the conversion output module; and/or, the capacitors in the first-mode operation module are symmetrically arranged about the capacitor in the conversion output module; and/or, each of the capacitors in the first-mode operation module has a recessed portion, a recessed area is formed by two recessed portions arranged oppositely, and the capacitor in the conversion output module is disposed in the recessed area; and/or, the capacitor in the conversion output module and the capacitors in the first-mode operation module are respectively disposed in a first zone and a second zone adjacent to the first zone, and along a connection direction, an projection of each of the capacitors in the first-mode operation module falls within an projection of the capacitor in the conversion output module, wherein the connection direction is perpendicular to a border between the first zone and the second zone.

16. A method for controlling the image sensor according to claim 1, comprising:
in the first mode: storing and reading out, based on the conversion output module and the first-mode operation module, at least one of the first set of signals and the second set of signals; and
in the second mode: reading out, based on the conversion output module and the second-mode operation module, at least one of the first set of signals and the second set of signals.

17. The method for controlling the image sensor according to claim 16, wherein
the first mode and the second mode operate independently, and the image sensor is configured to:
in the first mode: activate the conversion output module and the first-mode operation module, to store and read out at least one of the first set of signals and the second set of signals in the first mode; and
in the second mode: activate the conversion output module and the second-mode operation module, to read out both of the first set of signals and the second set of signals in the second mode;
or, the first mode and the second mode operate in conjunction, wherein the image sensor is configured to:
in a reset phase: reset at least a floating diffusion node and the conversion output module;
in an exposure phase: generate, by the conversion output module, the pixel signal and the overflow signal based on photoelectric conversion;
in a transfer storage phase: configure the conversion output module to generate the first reset signal and store the first reset signal and the pixel signal to the first-mode operation module; and
in a readout phase: configure the first-mode operation module to read out the first reset signal and the pixel signal, the conversion output module to form the second reset signal, and the second-mode operation module to read out the the second reset signal and the overflow signal.

18. The method for controlling the image sensor according to claim 17, wherein the first mode and the second mode operate in conjunction, and the image sensor is further configured to:
after the exposure phase, read out the overflow signal and the second reset signal in the second mode, transfer and store the first reset signal and the pixel signal, and read out the first reset signal and the pixel signal in the first mode;
or,
after the exposure phase, transfer and store the first reset signal and the pixel signal, and read out the first reset signal and the pixel signal in the first mode and the overflow signal and the second reset signal in the second mode, wherein the second reset signal is read out either before or after the overflow signal.

19. The method for controlling the image sensor according to claim 17, wherein
the first-mode operation module comprises a first storage readout portion and the first storage readout portion comprises a first storage transistor, a second storage transistor, a first storage capacitor and a second storage capacitor; wherein an overflow portion in the conversion output module shares the first storage capacitor with the first storage readout portion, and the image sensor is configured to:
during reading out of the second set of signals in the independently operated second mode, perform a non-true correlation double sampling of the second set of signals based on the first storage capacitor, and/or
replace the second-mode operation module with the first-mode operation module and perform a correlation double sampling of the second set of signals based on the second storage capacitor;
the first-mode operation module comprises a second storage readout portion and the second storage readout portion comprises a fourth storage transistor, a fifth storage transistor, a third storage capacitor and a fourth storage capacitor; wherein the overflow portion in the conversion output module shares the third storage capacitor with the second storage readout portion, and the image sensor is configured to:
when the second set of signals is read out in the independently operated second mode, perform a non-true correlation double sampling of the second set of signals based on the third storage capacitor, and/or
replace the second-mode operation module with the first-mode operation module and perform a correlation double sampling of the second set of signals based on the fourth storage capacitor.

20. The method for controlling the image sensor according to claim 16, wherein the conversion output module comprises a gain portion,
in the first mode, the conversion output module outputs the first reset signal and the pixel signal corresponding to the gain portion under a first conversion gain and a second conversion gain, respectively, and the first-mode operation module stores and reads out the first reset signal and the pixel signal under the first conversion gain and the second conversion gain by corresponding storage readout portions; or, the conversion output module outputs the first reset signal and the pixel signal corresponding to the gain portion under any one of the first conversion gain and the second conversion gain, and the first-mode operation module stores and reads out the first reset signal and the pixel signal under the corresponding conversion gain; and/or,
in the second mode, the conversion output module outputs the first reset signal and the pixel signal under the first conversion gain and the second conversion gain, respectively, and the second reset signal and the overflow signal under the first conversion gain, and the second-mode operation module reads out the first reset signal and the pixel signal under the first conversion gain and the second conversion gain and the second reset signal and the overflow signal under the first conversion gain.
